(19) United States
(12) Patent Application Publication
(10) Pub. No.: US 2020/0198652 A1
(43) Pub. Date: Jun. 25, 2020

(54) NOISE ADAPTIVE WARNING DISPLAYS AND AUDIO ALERT FOR VEHICLE

(71) Applicant: Robert Bosch GmbH, Stuttgart (DE)

(72) Inventor: Anup S. Deshpande, Troy, MI (US)

(21) Appl. No.: 16/229,184

(22) Filed: Dec. 21, 2018

(51) Int. Cl. B60W 50/14; B60Q 9/00; B60Q 1/52; B60K 28/10

(52) U.S. Cl. CPC B60W 50/14; B60Q 9/008; B60W 2050/146; B60K 28/10; B60Q 1/52

(57) ABSTRACT

An adaptive warning system and method for adapting an alert to a vehicle operator based on noise in a vehicle interior compartment, includes a loudspeaker, a dashboard display, a noise level sensing device for providing a noise value, and an electronic processor having a memory. The electronic processor is configured to compare the noise value with a first threshold and when the noise value is not greater than the first threshold, provide an audio alert at regular sound level and providing a visual alert on a dashboard display at regular indicia size in a normal alert mode. The electronic processor is also configured to when the noise value is greater than the first threshold, provide the audio alert at an increased sound level and provide the visual alert on the dashboard display having an increased indicia size in a second enhanced alert mode.

### RELATED APPLICATIONS

Not Applicable

### BACKGROUND

The embodiments relate to noise adaptive warning displays and audio indications for a vehicle operator.

Noise is an issue for distracting a driver in a vehicle. Many times, human machine interface warnings are missed because of the noise level inside the vehicle. Noise can be caused by loud radio or music, loud conversations among passengers, outside noise because of open windows, children in a back seat, or outside sources, such as other car horns honking.

### SUMMARY

A method of providing increasing visual, audio and haptic alerts to a driver of a vehicle in response to increasing noise in a vehicle interior compartment is advantageous.

Another embodiment includes a method for providing a noise adaptive warning to a vehicle operator comprising determining a noise value in a vehicle interior compartment and comparing the noise value with a first threshold. When the noise value is not greater than the first threshold, the method provides an audio alert at regular sound level and provides a visual alert on a dashboard display at regular indicia size. When the noise value is greater than the first threshold, the method provides the audio alert at an increased sound level and provides the visual alert on the dashboard display having an increased indicia size.

Another embodiment includes an adaptive warning system for adapting an alert to a vehicle operator of a vehicle based on noise in a vehicle interior compartment. The adaptive warning system includes a loudspeaker, a dashboard display, a noise level sensing device for providing a noise value, and an electronic processor with a memory. The electronic processor is configured to compare the noise value with a first threshold and when the noise value is not greater than the first threshold, provide an audio alert at regular sound level and provide a visual alert on a dashboard display at regular indicia size in a normal alert mode. When the noise value is greater than the first threshold, the electronic processor is configured to provide the audio alert at an increased sound level and provide the visual alert on the dashboard display having an increased indicia size in a second enhanced alert mode.

Other aspects of the embodiments will become apparent by consideration of the detailed description and accompanying drawings.

### BRIEF DESCRIPTION OF THE DRAWINGS

FIG. 1 is a block diagram of an adaptive warning system for providing noise adaptive warning displays and sounds.

FIG. 2 is a flowchart of a method of operating the adaptive warning system, according to some embodiments.

FIG. 3 is a flowchart of a method of operating a collision avoidance sensing unit.

FIG. 4 is a front view of a vehicle interior that includes a windshield and part of a dashboard display, according to some embodiments.

FIG. 4A is an expanded view of a portion of the dashboard display of FIG. 4.

FIG. 5 is a front view of a vehicle interior that includes part of a dashboard display adapted to provide additional warning.

FIG. 5A is an expanded view of a portion of the dashboard display of FIG. 5 that is adapted to provide additional warning.

### DETAILED DESCRIPTION

Before any embodiments of the arrangements are explained in detail, it is to be understood that the arrangement is not limited in its application to the details of construction and the arrangement of components set forth in the following description or illustrated in the following drawings. The arrangement is capable of other embodiments and of being practiced or of being carried out in various ways.

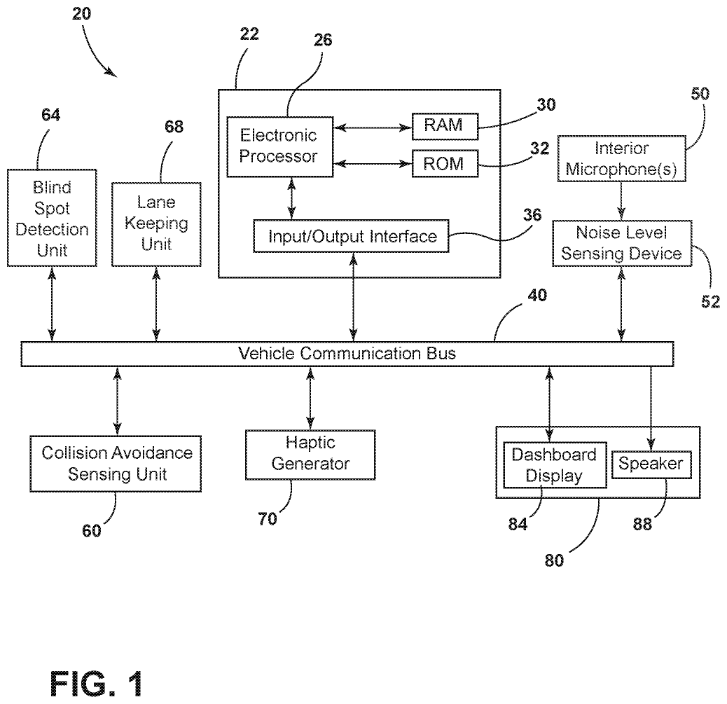

FIG. 1 illustrates an adaptive warning system 20 for a vehicle, such as a four-wheeled car or truck or the like. A driver assistance module 22 (“DAM”) analyzes vehicle interior noise level, and controls a vehicle display and loudspeaker, or other features based on the received noise level. The DAM 22 includes an electronic processor 26 and one or more non-transitory, computer-readable memory modules. In the example of FIG. 1, the DAM 22 includes a random access memory (“RAM”) module 30 and a read-only memory (“ROM”) module 32. The DAM 22 also includes an input/output interface 36 that transmits and receives data over a vehicle communication bus 40. The vehicle communication bus 40 can be a controller area network (“CAN”) bus, a CAN-FD (flexible data-rate) bus, a FlexRay bus or the like. The DAM 22 can include multiple processors, additional computer-readable memory modules, multiple I/O interfaces, and/or additional components or modules (e.g., hardware, software, or a combination thereof).

The electronic processor 26 of the DAM 22 is configured to receive information from the I/O interface 36 and process the information by executing instructions for one or more software modules (which may also be referred to as a “controller” or “controllers”) stored to a memory module, such as the ROM 32. The electronic processor 26 is configured to store information to and retrieve information from the RAM 30 (e.g., information received from other vehicle subsystems or sensors through the vehicle communication bus 40 and information generated by modules executed by the electronic processor 26). The non-transitory computer readable memory modules of the DAM 22 include volatile memory, non-volatile memory, or a combination thereof and, in various constructions, may also store operating system software, applications/instructions data, and combinations thereof.

Various other vehicle subsystems, are also connected to the vehicle communication bus 40 to communicate with the DAM 22, including various vehicle sensors, and the other vehicle subsystems. For example, FIG. 1 shows at least one interior microphone 50 that senses noise and sound in a vehicle interior. In one embodiment, four microphones are disposed evenly in a vehicle to sense sound in all areas of the vehicle interior. Any number of microphones is contemplated. The interior microphone 50 provides an output to a noise level sensing device 52. The noise level sensing device 52 operates to sense a noise value (decibels) to the DAM 22 via the vehicle communication bus 40.

The adaptive warning system 20 also includes a collision avoidance sensing unit 60 connected to the vehicle communication bus 40. The collision avoidance sensing unit 60 includes one of more from a group consisting of LIDAR, radar, video imaging and other arrangements for determining presence of objects around a vehicle. The collision avoidance sensing unit 60 provides a forward collision warning to a vehicle operator. Further, the adaptive warning system 20 includes a blind spot detection unit 64 for sensing and detecting a vehicle in a blind spot and providing a blind spot warning to a vehicle operator. Finally, a lane keeping unit 68 includes sensors and is configured to provide a lane departure warning to a vehicle operator when the vehicle drifts out of a driving lane.

FIG. 1 shows a haptic generator 70 that is provided with a vehicle steering wheel. The haptic generator 70 is configured for vibrating the steering wheel to obtain the attention of a driver of the vehicle and thus provide a haptic alert.

Finally, FIG. 1 shows a human machine interface 80 that includes a dashboard display 84 and a vehicle interior loudspeaker 88 connected to the vehicle communication bus 40. In some embodiments, the loudspeaker 88 outputs a chime sound as an audio alert. Other voice or audio alerts are also contemplated. In some embodiments, the human machine interface 80 may include a touchscreen. The dashboard display 84 may include OLED, LCD, LED and/or other display light sources.

Each of these vehicle sub-systems, sensors, or arrangements shown in FIG. 1 is connected to the vehicle communication bus 40 and is capable of exchanging information with other vehicle devices, sub-systems, sensors, or arrangements connected to the vehicle communication bus 40. Other devices (not shown) are also connected to the vehicle communication bus 40.

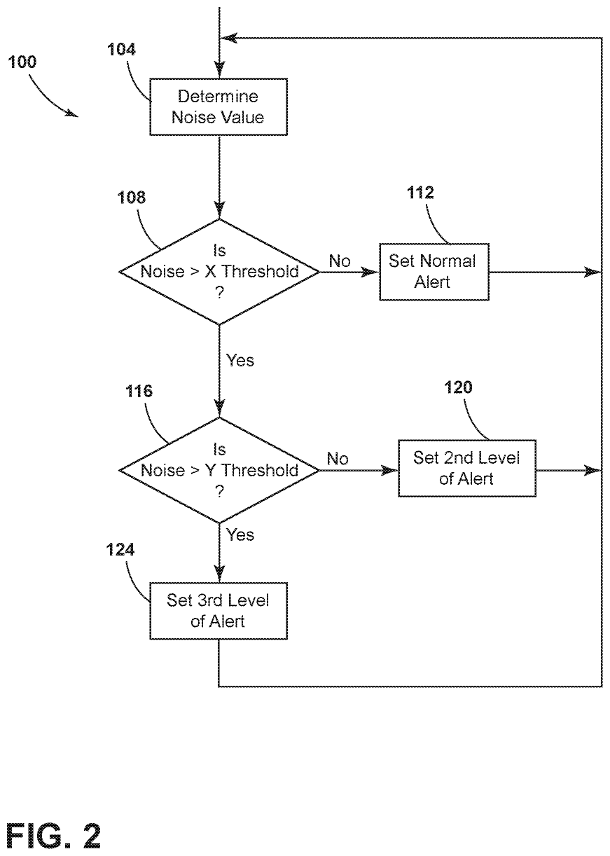

FIG. 2 is a flowchart 100 showing operation of a DAM 22 in one embodiment for the adaptive warning system 20.

In operation, the noise level sensing device 52 senses noise in the vehicle interior compartment of a vehicle and provides a noise value to the electronic processor 26 via the communication bus 40 and the input/output interface 36 (step 104).

The electronic processor 26 is configured to execute a program that provides a level of alert for the adaptive warning system 20 depending on sound or noise value detected in the vehicle interior compartment as follows. First, the electronic processor compares the noise value with a first threshold or normal X_{threshold} value at decision step 108. When the noise value is not greater than the X_{threshold} value, the electronic processor 26 advances to step 112. At step 112, the electronic processor 26 is configured to set the adaptive warning system 20 to normal alert mode. In the normal alert mode, the warning sounds or chimes provided to a driver are at a normal sound level as an audio alert and the warning message or visual alert is provided on a dashboard display normal in size.

When the noise value is greater than the X_{threshold} value at decision step 108, the electronic processor 26 is configured to advance to decision step 116. At decision step 116, the electronic processor 26 is configured for comparing the noise value with a second threshold defined as a Y_{threshold} value, wherein Y_{threshold} value>X_{threshold} value.

When the noise value is not greater than the Y_{threshold} value at decision step 116, the electronic processor advances to step 120. At step 120, the electronic processor 26 sets the adaptive warning system 20 to a second enhanced alert mode. In the second enhanced alert mode, the warning sounds or chimes provided to a vehicle operator are adapted to have at an enhanced level or increased sound level, which is louder than the normal level. Further, a visual alert, such as a warning message or indicia is provided on the dashboard display having enhanced or enlarged characters that are more noticeable to a vehicle operator. Thus, the adaptive warning system 20 operates for adapting the visual alert and the audio alert based on detected noise in the vehicle interior compartment.

When the noise value is greater than the second threshold of Y_{threshold} value at decision step 116, the electronic processor advances to step 124. At step 124, at a third alert mode caused by increased noise or sound in the vehicle interior compartment. In the third alert mode, the warning sounds or audio alert for a vehicle operator is provided at a greater enhanced or second increased sound level than in the second enhanced alert mode. Further, a visual alert of a warning message or indicia will have an even greater, second increased indicia size on a dashboard display. Finally, the haptic generator 70 vibrates the steering wheel of the vehicle in one embodiment of the third alert mode to increase the level of alert to the vehicle operator.

While FIG. 2 shows two threshold levels and three alert modes, additional threshold levels and alert modes are contemplated.

Collision Avoidance Operation

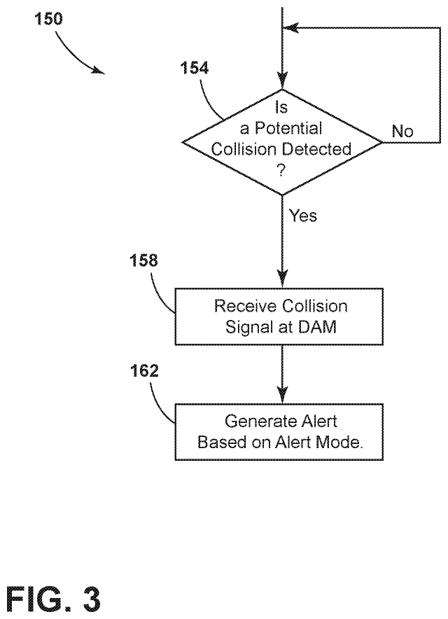

FIG. 3 shows operation of a flowchart 150 of a method for operating the collision avoidance sensing unit 60 to generate an alert.

At decision step 154, the collision avoidance sensing unit 60 utilizes multiple sensors and determines a potential collision due to relative movement of a vehicle with respect to other vehicles and provides an output collision signal to the vehicle communication bus. When a collision is not detected, the decision step 154 is repeated. When a collision is detected, the electronic processor 26 of the DAM 22 receives the collision signal at step 158.

In response to the collision signal, the electronic processor 26 advances to step 162 in FIG. 3 and operates to determine what alert mode is in use from the operation shown in FIG. 2 and generates an alert based on the alert mode. Thus, a regular alert, second level alert or 3^{rd} level alert is provided.

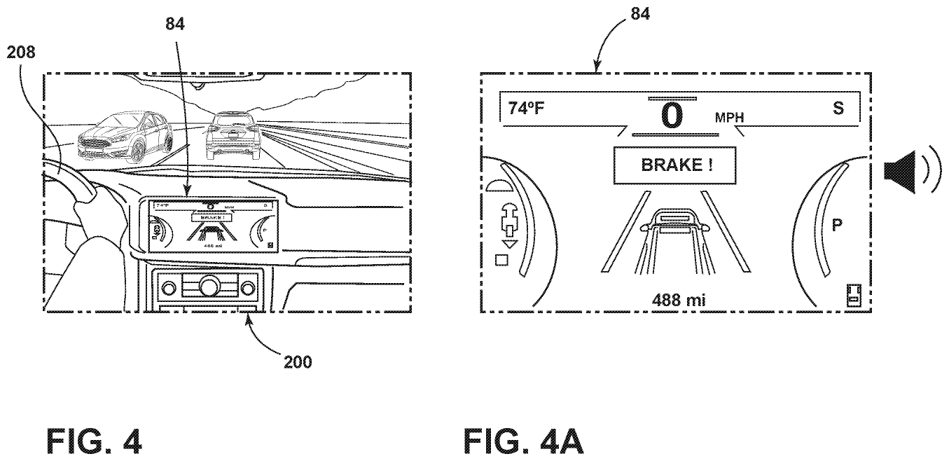

FIG. 4 shows a partial front view of a vehicle interior compartment 200 that includes a dashboard display 84 and a steering wheel 208 when a regular collision alert is provided. The regular alert is provided by operating the loudspeaker 88 at a regular or normal noise level. FIG. 4A shows a view of indicia “BRAKE !” displayed on the dashboard display 84 provided to a vehicle operator to avoid a potential collision. Thus, a chime sound is output at a normal level when the collision avoidance sensing unit 60 senses a potential collision and triggers a warning and the DAM 22 has a noise value below X_{threshold} value in the interior compartment of the vehicle.

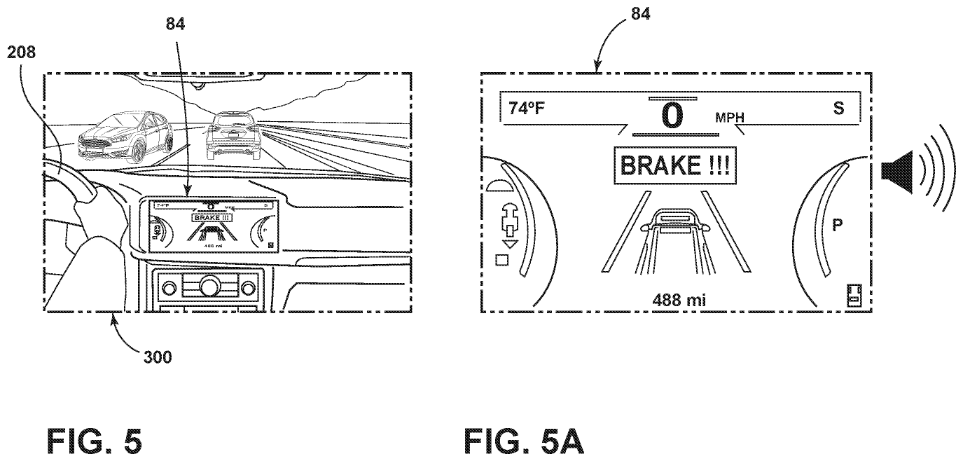

FIG. 5 shows a partial front view of a vehicle interior compartment 300 that includes a dashboard display 84 and a steering wheel 208 when a second level collision alert is provided. In an instance when the noise value is above the X threshold value, but below the Y_{threshold} value, the adaptive warning system 20 provides the warning illustrated in FIG. 5. In FIG. 5, the indicia “BRAKE !!!” is larger in character size and includes more exclamation marks. FIG. 5A better illustrates the indicia displayed on the dashboard display 84. Further, the chime sound is increased in intensity so that the vehicle operator is able to hear the sound. Between the increased audio and visual stimulus to the vehicle operator, the likelihood of the vehicle operator timely actuating the vehicle brakes increases.

In an instance when the noise value is above the Y_{threshold} value, the indicia on the dashboard display 84 can be further increased in size and/or characters, the chime sound or warning can be increased in intensity, and the haptic generator 70 operates to vibrate the steering wheel 208 to alert the vehicle operator to a need to brake or take other action.

Other arrangements having other indicia is contemplated. In an instance when a vehicle is in a blind spot, the blind spot detection unit 64 provides a blind spot warning/message or other visual alert to the dashboard display 84 in combination with an audio alert. In one embodiment, the indicia and audio alert are modified in size and sound intensity depending on noise level as set forth above with respect to the FIG. 2 embodiment above.

In another arrangement, the lane keeping unit 68 provides a lane departure warning to a vehicle operator when the vehicle begins drifting toward another lane without signaling or when a vehicle moving in same direction is present in an adjacent lane. The lane departure warning may include a haptic alert provided by the haptic generator 70 and a vehicle steering wheel, along with a visual alert and an audio alert. The visual alert increases in size and the audio alert increases in sound intensity depending on the noise level detected as disclosed in the FIG. 2 embodiment above.

The memory modules 30, 32 can include a program storage area (e.g., read only memory (ROM) 32 and a data storage area (e.g., random access memory (RAM) 30, and another non-transitory computer readable medium. The electronic processor 26 executes software stored in the memory 32. The software may include instructions and algorithms for performing methods as described herein.

The input/output interface 36 shown in FIG. 1 receives inputs and provides outputs to and from systems external to the DAM 22, including the devices and systems shown in FIG. 1. In some embodiments, the DAM 22 includes a plurality of electrical and electronic components that provide power, operational control, and protection to the components and modules within the electronic processor 26. It should be understood that the DAM 22 may include additional, fewer, or different components.

The DAM 22 includes the input/output interface 36 for sending and receiving information from one or more sensors or systems external to the electronic processor 26 over the vehicle communication bus 40. In some implementations, the adaptive warning system 20 can also include one or more additional internal sensors or systems.

The adaptive warning system 20 is hosted in the driver assistance module 22 as shown in FIG. 1. In other embodiments, the adaptive warning system 20 is hosted another electronic control unit.

In another embodiment, the visual alert is provided on a heads-up display provided toward a windshield field of view of the vehicle operator.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

It should also be noted that a plurality of hardware and software based devices, as well as a plurality of different structural components may be used to implement the embodiments. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the embodiments may be implemented in software (e.g., stored on non-transitory computer-readable medium) executable by one or more processors. As such, it should be noted that a plurality of hardware and software based devices, as well as a plurality of different structural components may be utilized to implement the embodiments. For example, “electronic processors” and “driver assistance modules” described in the specification can include standard processing components, such as one or more processors, one or more memory modules including non-transitory computer-readable medium, one or more input/output interfaces, and various connections (e.g., a system bus) connecting the components.

Thus, the above arrangements provide, among other things, methods and systems for providing adaptive visual and audio warnings to a vehicle operator based on noise detected in a vehicle interior compartment.

What is claimed is:

1. A method for providing a noise adaptive warning to a vehicle operator, comprising:
determining a noise value in a vehicle interior compartment;
comparing the noise value with a first threshold;
when the noise value is not greater than the first threshold, providing an audio alert at regular sound level and providing a visual alert on a dashboard display at regular indicia size; and
when the noise value is greater than the first threshold, providing the audio alert at an increased sound level and providing the visual alert on the dashboard display having an increased indicia size.

2. The method according to claim 1, wherein the audio alert includes a chime that is output by a loudspeaker.

3. The method according to claim 2, wherein the visual alert includes a message that is displayed on the dashboard display.

4. The method according to claim 1, wherein when the noise value is greater than the first threshold and not greater than a second threshold, the audio alert is provided at the increased sound level and the visual alert is provided on the dashboard display having the increased indicia size, and
when the noise value is greater than the second threshold, the audio alert is provided at a second increased sound level, and a haptic alert is provided with a vehicle steering wheel.

5. The method according to claim 4, wherein when the noise value is greater than the second threshold, the visual alert is provided on the dashboard display having a second increased indicia size and additional characters.

6. The method according to claim 4, wherein a collision avoidance sensing unit senses a potential collision and triggers the audio alert and the visual alert.

7. The method according to claim 1, wherein a collision avoidance sensing unit senses a potential collision and triggers the audio alert and the visual alert.

8. The method according to claim 1, wherein determining the noise value in the vehicle interior compartment includes at least one interior microphone to receive sound and a noise level sensing device to sense the sound and provide the noise value to a vehicle communication bus.

9. The method according to claim 8, wherein the comparing of the noise value with the first threshold is performed by an electronic processor of a driver assistance module.

10. An adaptive warning system for adapting an alert to a vehicle operator of a vehicle based on noise in a vehicle interior compartment, comprising:
a loudspeaker;
a dashboard display;
a noise level sensing device for providing a noise value;
an electronic processor and a memory, wherein the electronic processor is configured to compare the noise value with a first threshold and:
when the noise value is not greater than the first threshold, provide an audio alert at regular sound level and providing a visual alert on the dashboard display at regular indicia size in a normal alert mode; and
when the noise value is greater than the first threshold, provide the audio alert at an increased sound level and provide the visual alert on the dashboard display having an increased indicia size in a second enhanced alert mode.

11. The adaptive warning system of claim 10, wherein the electronic processor is configured to:
when the noise value is greater than the first threshold and not greater than a second threshold, the audio alert is provided at the increased sound level and the visual alert is provided on the dashboard display having the increased indicia size, and
when the noise value is greater than the second threshold, the audio alert is provided at a second increased sound level, and a haptic alert is provided with a vehicle steering wheel.

12. The adaptive warning system according to claim 11, wherein when the noise value is greater than the second threshold, the visual alert is provided on the dashboard display having a second increased indicia size and additional characters.

13. The adaptive warning system according to claim 11, wherein a collision avoidance sensing unit senses a potential collision and triggers the audio alert and the visual alert.

14. The adaptive warning system according to claim 11, including a haptic generator for vibrating the steering wheel.

15. The adaptive warning system according to claim 10, wherein the audio alert includes a chime that is output by the loudspeaker.

16. The adaptive warning system according to claim 10, wherein a collision avoidance sensing unit senses a potential collision and triggers the audio alert and the visual alert.

17. The adaptive warning system according to claim 10, including at least one interior microphone in the vehicle interior compartment to receive sound and provide the sound to the noise level sensing device.

18. The adaptive warning system according to claim 10, wherein the noise level sensing device provides the noise value to the electronic processor via a vehicle communication bus.

19. The adaptive warning system according to claim 10, wherein a blind spot detection unit senses a vehicle in a blind spot and provides the audio alert and the video alert.

20. The adaptive warning system according to claim 10, wherein a lane keeping unit senses a lane departure and triggers the audio alert, the visual alert, and a haptic alert.
